(19) United States
(12) Patent Application Publication
(10) Pub. No.: US 2011/0271047 A1
(43) Pub. Date: Nov. 3, 2011

(54) STORAGE DEVICE IN COMPUTER SYSTEM AND METHOD FOR CONTROLLING THE SAME

(75) Inventors: Xun Zhang, Suzhou (CN); Yu Huang, Suzhou (CN); Ye-Chun Zhang, Suzhou (CN)

(73) Assignees: ASUSTeK COMPUTER INC., Taipei (TW); ASUS TECHNOLOGY (SUZHOU) CO. LTD, Suzhou (CN)

(21) Appl. No.: 12/857,657

(22) Filed: Aug. 17, 2010

(30) Foreign Application Priority Data
Apr. 30, 2010 (TW) 099113938

(51) Int. Cl. G06F 12/02; G06F 12/00

(52) U.S. Cl. 711/112; 711/154; 711/171; 711/E12.001; 711/E12.002

(57) ABSTRACT

A storage device of a computer system including a first storage portion having a first capacity and a second storage portion having a second capacity is disclosed. A virtual storage unit is installed in an operating system of the computer system, and the operating system directly accesses data in the first capacity of the storage device. The operating system accesses the data in the second capacity via the virtual storage unit mapped to the second capacity of the storage device. The invention may be adapted to the storage device which uses a MBR partition table scheme and has a capacity larger than 2.2 TB which is the maximum supportive capacity of the MBR partition table scheme.

### FIELD OF THE INVENTION

The invention relates to a storage device in a computer system and the method for controlling the same, and, more particularly, to a storage device with large capacity programmed by a master boot record (MBR) partition table scheme in a computer system and the method for controlling the same.

### BACKGROUND OF THE INVENTION

To be compatible with International Business Machines Corporation (IBM) computers in early days, a master boot record (MBR) partition table scheme is used to program hard disks. In a disk partition table, the length of each logical block address is stored as 32 bits, and the size of each logical block is 512 bytes. Therefore, conventionally, when the hard disk is programmed by the MBR partition table scheme, the maximum supportive capacity is: 2³²×512(byte)=2.2 trillion bytes (TB).

With the fast development of the storage device, the storage devices whose capacity is larger than 2.2 TB are developed. As shown in FIG. 1, it is schematic diagram showing a storage device which is programmed by the MBR partition table scheme and has a capacity larger than 2.2 TB. When programmed by the MBR partition table scheme, the storage device 100 with the capacity A only can support 2.2 TB capacity, which is the first storage portion 104. Since the logical block address of the MBR can only locate 2.2 TB capacity, a remaining second storage portion 108 with (A-2.2) TB capacity cannot be used. For example, if the hard disk has a 2.5 TB capacity, after it is programmed by the MBR partition table scheme, the 0.3 TB (300 gigabyte (GB)) capacity cannot be used. Therefore, the storage device 100 having a total capacity 2.5 TB in the computer system in various operating systems such as disk operating system (DOS), Linux or Windows 150, only 2.2 TB capacity can be used. In other words, the first storage portion 104 with 2.2 TB capacity in the storage device 100 may be accessed via the operating system 150, and the remaining second storage portion 108 with (A-2.2) TB capacity cannot be accessed via the operating system150.

The size of the above logical block is, for example, 512 bytes, and if the size of the logical block is 2048 bytes, the maximum supportive capacity of the storage device programmed by the MBR partition table scheme is 8.8 TB. The maximum supportive capacity is 2.2 TB hereinafter, and it is not limited in the invention.

As a result, a GUID partition table scheme is disclosed to program the storage device. To the computer system having a motherboard with traditional BIOS, the current operating system (such as Linux or Windows) can read information in the storage device programmed by the GUID partition table scheme, but the computer system cannot be booted from the storage device.

Consequently, if the computer system needs to be booted from the storage device programmed by the GUID partition table scheme, the computer system needs to have a motherboard with a new extensible firmware interfaces (EFI) BIOS. However, not only the new BIOS different from the traditional BIOS needs to be updated, the operating system and other applications also needs to be updated, which increases the expense of the user.

### SUMMARY OF THE INVENTION

The invention discloses a storage device in a computer system and the method for controlling the same. The storage device is adapted to the computer system having a traditional basic input/output system (BIOS). To the storage device with maximum supportive capacity programmed by the MBR partition table scheme, the computer system may access the maximum storage capacity as well as the capacity exceeding the maximum supportive capacity in the storage device.

The invention discloses a storage device in a computer system including a first storage portion having a first capacity, and a second storage portion having a second capacity. A virtual storage unit is installed in an operating system of the computer system, and the operating system may directly access data in the first capacity of the storage device. In addition, the operating system may access the second capacity via the virtual storage unit mapped to the second capacity in the storage device.

The invention further discloses a method for controlling the storage device in the computer system. The method includes the steps of: detecting whether a storage device programmed by the MBR partition table scheme in the computer system exists; detecting whether the total capacity of the storage device is larger than a first capacity when the storage device programmed by the MBR partition table scheme exists, and generating a virtual storage unit for controlling the second capacity when the total capacity of the storage device is larger than the first capacity, and the second capacity is smaller than or equal to the capacity resulting from the total capacity minus the first capacity of the storage device. An operating system of the computer system directly accesses the data in the first capacity in the storage device, and the operating system accesses data in the second capacity via the virtual storage unit.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a storage device which is programmed by the MBR partition table scheme and has a capacity larger than 2.2 TB in the prior art;

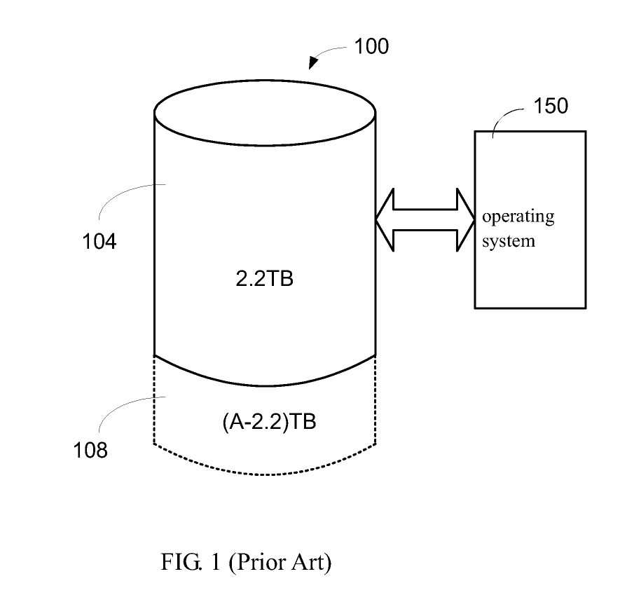

FIG. 2 is a schematic diagram showing a storage device which is programmed by the MBR partition table scheme and has a capacity larger than 2.2 TB in an embodiment of the invention; and

FIG. 3 is a flow chart showing the method for generating the virtual storage unit in an embodiment of the invention.

### DETAILED DESCRIPTION OF THE PREFERRED EMBODIMENT

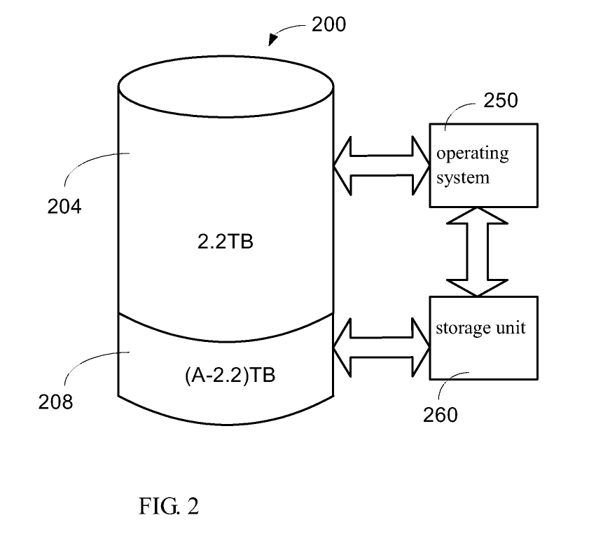

FIG. 2 is a schematic diagram showing a storage device which is programmed by the MBR partition table scheme and has a capacity larger than 2.2 TB in an embodiment of the invention. The storage device 200 with the capacity A programmed by the MBR partition table scheme can support 2.2 TB capacity, which is the first storage portion 204. The user may access the data in the first storage portion 204 with 2.2 TB capacity in the storage device 200 via the operating system 250 to. In addition, the user may install an application in the operating system 250. The application may simulate a virtual storage unit 260, and the virtual storage unit 260 controls a mapped second capacity. The second capacity may be the remaining capacity exceeding the 2.2 TB in the total capacity of the storage device 200, and for example, the capacity equals to or less than (A-2.2)TB. The user may access the data in the virtual storage unit 260 via the operating system 250.

According to an embodiment of the invention, the second capacity of the virtual storage unit 260 is (A-2.2) TB, and that is, the virtual storage unit 260 may be mapped to the second storage portion 208 of the storage device 200. When the user accesses the data in the virtual storage unit 260 via the operating system 250, the application may transmit the accessed data to the (A-2.2) TB capacity of the mapped second storage portion 208.

In addition, the application may set the virtual storage unit 260 to be a hard disk, a network adapter, a CD-ROM driver and other physical devices, or a file, a volume, a partition and other virtual devices. In the embodiment of the invention, the second capacity is (A-2.2) TB, and it also may be smaller than (A-2.2) TB. For example, the (A-2.2) TB capacity can be divided into multiple blocks, and each block may be controlled by a corresponding virtual storage unit. The virtual storage unit is equipment or an equipment combination directly or indirectly with an information storage function.

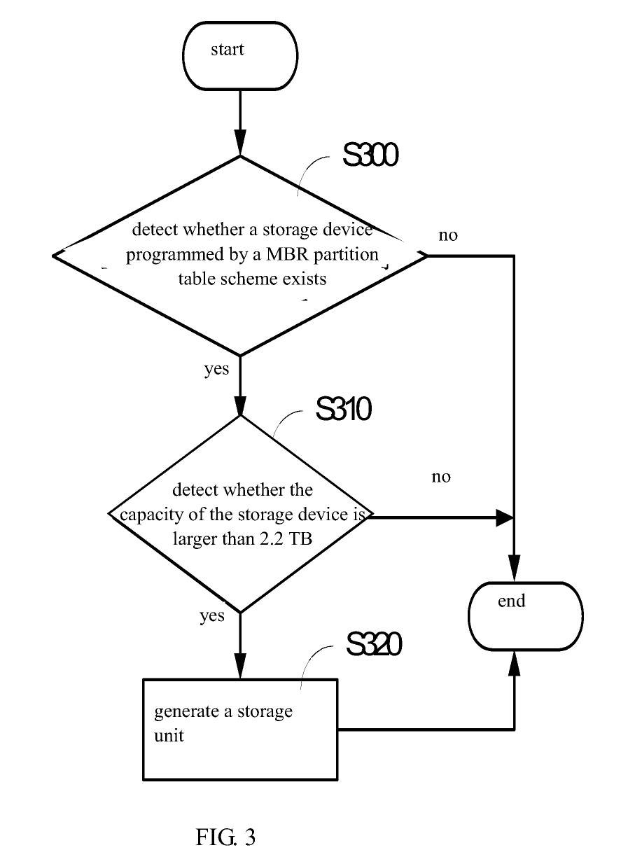

FIG. 3 is a flow chart showing the method for generating the virtual storage unit in the embodiment of the invention. Firstly, whether a storage device programmed by the MBR partition table scheme exists in the computer system is detected (step S300). If step S300 returns YES, whether the total capacity of the storage device is larger than 2.2 TB is detected (step S310). If step S310 step returns YES, a virtual storage unit is generated (step S320), and the capacity of the virtual storage unit equals to the remaining capacity which exceeds the capacity of 2.2 TB in the total capacity. Therefore, after the virtual storage unit is generated, the user may access the data in the virtual storage unit via the operating system.

Consequently, the invention discloses a storage device of the computer system and the method for controlling the same. The storage device is adapted to the computer system with a traditional BIOS. After the storage device with the capacity larger than 2.2 TB is programmed by the MBR partition table scheme, the user may access the data within or exceeding the 2.2 TB capacity in the storage device with any operating system (such as the Linux or Windows) capable of supporting the MBR partition table scheme.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A storage device of a computer system comprising:
a first storage portion having a first capacity; and
a second storage portion having a second capacity;
wherein a virtual storage unit is installed in an operating system of the computer system, the operating system directly accesses data in the first capacity of the storage device, and the operating system accesses the data in the second capacity of the storage device via the virtual storage unit mapped to the second capacity.

2. The storage device according to claim 1, wherein the first capacity is a maximum supportive capacity programmed by a master boot record (MBR) partition table scheme.

3. The storage device according to claim 1, wherein the operating system supports the MBR partition table scheme.

4. The storage device according to claim 3, wherein the operating system supporting the MBR partition table scheme is a disk operating system (DOS), a Linux operating system or a Windows operating system.

5. The storage device according to claim 1, wherein the first capacity is 2.2 trillion bytes (TB) or 8.8 TB.

6. The storage device according to claim 1, wherein the second capacity is equal to or smaller than the capacity resulting from a total capacity minus the first capacity.

7. A method for controlling a storage device in a computer system, comprising the steps of:
detecting whether the computer system has a storage device programmed by a MBR partition table scheme;
detecting whether a total capacity of the storage device is larger than a first capacity when the storage device programmed by the MBR partition table scheme exists; and
generating a virtual storage unit for controlling a second capacity when the total capacity of the storage device is larger than the first capacity,
wherein the second capacity is smaller than or equal to the capacity resulting from the total capacity minus the first capacity;
wherein an operating system of the computer system directly accesses data in the first capacity of the storage device, and the operating system accesses the data in the second capacity via the virtual storage unit.

8. The controlling method according to claim 7, wherein the operating system supports the MBR partition table scheme.

9. The controlling method according to claim 8, wherein the operating system is a Linux operating system or a Windows operating system.

10. The controlling method according to claim 7, wherein the first capacity is a maximum supportive capacity programmed by the MBR partition table scheme.

11. The controlling method according to claim 10, wherein the maximum supportive capacity programmed by the MBR partition table scheme is 2.2 TB or 8.8 TB.
